(19) United States
(12) Patent Application Publication
(10) Pub. No.: US 2007/0217021 A1
(43) Pub. Date: Sep. 20, 2007

(54) GHOST IMAGE ELIMINATION IN AN IMAGE SENSOR EMPLOYING A VARIABLE FOCUS LENS

(75) Inventors: Bernardus H.W. Hendriks, Eindhoven (NL); Marco A.J. Van As, Eindhoven (NL); Stein Kuiper, Vught (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,466

(22) PCT Filed: Mar. 31, 2005
(86) PCT No.: PCT/IB05/51082

§ 371 Date: Sep. 29, 2006

(30) Foreign Application Priority Data
Apr. 2, 2004 (GB) 0407492.8

(51) Int. Cl. G02B 3/12

(52) U.S. Cl. 359/666

(57) ABSTRACT

In an image sensor incorporating a variable focus lens of the electrowetting type, means are provided for reducing or substantially eliminating the occurrence of ghost images. A variable focus lens of the above-mentioned type comprises a housing (5) provided with a first fluid (A) and an axially displaced second fluid (B), the two fluids being non-miscible, in contact over a meniscus (14) and having different indices of refraction. First and second electrodes (2,12) are provided and the shape of the meniscus (14) is controllable in dependence on the application of a voltage between the first and second electrodes (2,12). Various methods of reducing or substantially eliminating the occurrence of ghost images are prepared, including the alteration of the optical properties of an inner and/or outer wall of the housing (5), to reduce the reflectivity thereof, provision of means in the image sensor to intercept ghosting and appropriate selection of the material or combination of materials of which the housing (5) is formed.

This invention relates to ghost image elimination in a variable focus lens and, more particularly, to ghost image reduction/elimination in a variable focus lens of the type comprising a first fluid and a second fluid, the fluids being immiscible, having different indices of refraction and being in contact over a meniscus, wherein the lens function of said variable focus lens can be selectively controlled.

A fluid is a substance that alters its shape in response to any force, that tends to flow or to conform to the outline of its chamber, and that includes gases, liquids and mixtures of solids and liquids capable of flow. Furthermore, the lens function of a variable focus lens is its ability to focus (converge or diverge) one or more wavelengths of light.

In camera modules, so-called ghost images can arise when unintended reflections occur on surfaces making up the lens stack, and these reflections can, after being imaged by the remaining parts of the optical system, reach the image sensor and produce unwanted artifacts in the image. This can occur, for example, where the inner surface of the optical housing is reflective. Specular reflection at the inner surface of the housing will cause a portion of the light beam to be scattered and this scattered radiation is then converged by the remaining parts of the optical system at a point to the side of the light beam creating the main image, so as to create a ghost image close to the periphery of the main image. In order to overcome this problem, in conventional camera modules, it is possible to make the inner surface of the housing rough, so as to significantly reduce its reflectivity and, therefore, the occurrence of ghost images.

The same effect can occur in a camera module containing a variable focus lens based on two fluids, such as a so-called electrowetting lens, which is a variable focus lens comprising a fluid chamber within which is provided a first fluid and an axially displaced second fluid, the two fluids being non-miscible, in contact over a meniscus and having different indices of refraction. Such an electrowetting lens typically further comprises a first electrode and a second electrode, whereby the shape of the meniscus is variable in dependence on the application of a voltage between the first and second electrodes. Other types of variable focus lens are known which are based on a chamber in which is provided two immiscible fluids having different indices of refraction and being in contact over a meniscus, in which the lens function of the lens can be selectively controlled by varying the shape and/or position of the meniscus, as will be apparent to a person skilled in the art. Further specific exemplary embodiments of such variable focus lenses will be described in more detail.

In the event that the fluid chamber is transparent, ghost images can arise as a result of reflections on the outer boundary of the fluid chamber or housing. This is due to the fact that the refractive index difference between the fluid and the housing is relatively small compared to the refractive index change between the housing and the surrounding medium. In one known arrangement, the fluid chamber may comprise a transparent glass cylinder with transparent electrodes and coatings, which arrangement is very susceptible to ghost images, particularly when the outer part of the cylinder interfaces with air, giving rise to the significant refractive index step referred to above.

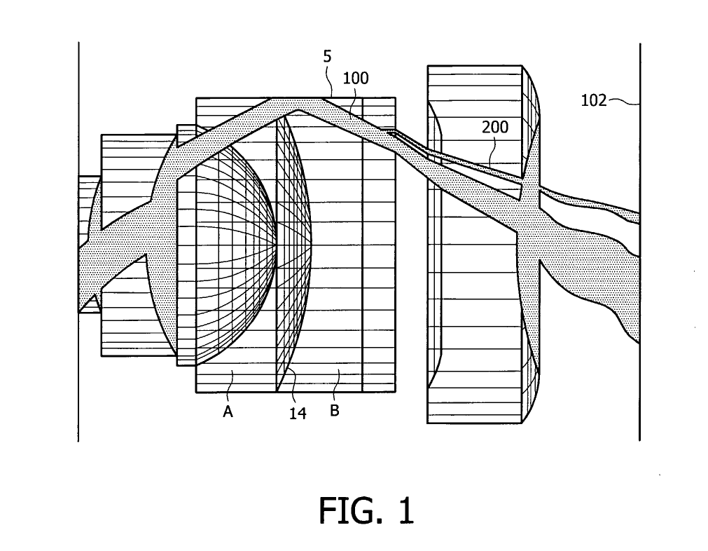

If the fluid chamber is made of, for example, a metal, the interior wall thereof is generally highly reflective, which leads to the occurrence of ghost images, as explained above, and as illustrated in FIG. 1 of the drawings, which shows an imaging system having a lens stack which includes an electrowetting lens arrangement comprising a fluid chamber 5 within which is provided a first fluid A and a second fluid B, the first and second fluids A, B being non-miscible, in contact over a meniscus 14 and having different indices of refraction. First and second electrodes (not shown) are provided and the shape of the meniscus 14 is controllable in dependence on the application of a voltage between the first and second electrodes.

A light beam 100 passes through the lens stack to the electrowetting lens, and at least a portion of the incident light beam 100 is reflected by the reflective inner wall of the fluid chamber 5 toward the remaining parts of the optical system and, from there, to the image surface 102. However, due to specular reflection at the inner wall of the fluid chamber 5, a portion 200 of the incident light beam 100 is scattered and then converged to another point on the image surface 102, so as to create a ghost image at the periphery of the main image. This is a particular problem in the case where the housing 5 is made of a polished metal, as a result of which the imaging module is very susceptible to the occurrence of ghost images.

This is obviously undesirable, but it is not possible to solve this problem as in conventional camera modules by making the inner surface of the fluid chamber 5 rough, because the edge of the meniscus 14 needs a smooth surface, in order to obtain a uniformly shaped meniscus.

It is an object of the present invention to provide a method of reducing or substantially eliminating the occurrence of ghost images in a variable focus lens of the type comprising a first fluid and a second fluid, the two fluids being immiscible, having different indices of refraction and being in contact over a meniscus, wherein the lens function of the variable focus lens can be selectively controlled by varying the shape and/or position of the meniscus. It is also an object of the present invention to provide a variable focus lens of this type in which the occurrence of ghost images is reduced or substantially eliminated, an image sensor including such a variable focus lens, an image capture device including such an image sensor, and portable telecommunications apparatus incorporating such an image capture device.

In accordance with the present invention, there is provided a method of reducing or substantially eliminating the occurrence of ghost images in a variable focus lens comprising a housing in which is provided a first fluid and a second fluid, the fluids being non-miscible, in contact over a meniscus and having different indices of refraction, the shape and/or position of said meniscus being variable so as to selectively control the lens function of said variable focus lens, a portion of the inner wall of said housing being contactable by said meniscus during operation, which portion of said inner wall is substantially smooth, the method comprising configuring or altering the optical properties of at least a portion of the wall of said housing so as to at least reduce the reflectivity thereof.

Also in accordance with the present invention, there is provided a variable focus lens comprising a housing in which is provided a first fluid and a second fluid, the fluids being non-miscible, in contact over a meniscus and having different indices of refraction, the shape and/or position of said meniscus being variable so as to selectively control the lens function of said variable focus lens, a portion of the inner wall of said housing being contactable by said meniscus during operation, which portion of said inner wall is substantially smooth, wherein the optical properties of at least a portion of the wall of said housing has been configured or altered so as to at least reduce the reflectivity thereof and thereby reduce or substantially eliminate the occurrence of ghost images during operation.

The optical properties of the inner and/or outer wall of the housing, and/or the bulk of the wall of the housing, may be configured or altered so as to at least reduce the reflectivity thereof.

The present invention also extends to an image sensor having a variable focus lens comprising a housing in which is provided a first fluid and a second fluid, the fluids being non-miscible, in contact over a meniscus and having different indices of refraction, the shape and/or position of said meniscus being variable so as to selectively control the lens function of said variable focus lens, the image sensor further comprising means for reducing or substantially eliminating the occurrence of ghost images in said variable focus lens.

In one exemplary embodiment, the housing may be formed of a substantially transparent material, wherein at least a portion of the outer surface of said housing is provided with a light-absorbing coating or layer. At least a portion of the outer surface of the housing may be highly scattering and/or the outer surface of the housing may be coupled with a light-absorbing outer body, for example, the housing may be substantially encapsulated in a mount formed of a light absorbing material.

In one exemplary embodiment, the second fluid may be axially displaced from the first fluid, and the lens may further comprise a first electrode and a second electrode, wherein the shape of the meniscus can be controlled in dependence on the application of a voltage between said first electrode and said second electrode.

In this case the first electrode may comprise a conducting coating applied to the inner wall of the housing, in which case, a thin substantially transparent light-absorbing coating may be provided between the inner wall of the housing and the electrode to reduce or substantially eliminate ghost images in accordance with an exemplary embodiment of the invention.

The housing may be made of a translucent and/or absorbing material, or a light absorbing material can be mixed through the housing material before it is moulded into a housing. In yet another exemplary embodiment, the outer wall of the housing may be shaped such that at least some ghost images do not reach the image sensor. Alternatively, the outer wall of the housing may be provided with a blazed Fresnel structure, which may save space relative to the specific shaping of the outer wall of the housing to prevent ghost images from reaching the image sensor.

In the case of the image sensor of the invention, this may be provided with a stop arranged and configured to intercept at least a portion of ghosting occurring as a result of specular reflection of light by the housing.

It will be appreciated that any combination of the above measures can be employed.

The housing may be formed of an opaque, reflective material, such as (polished) metal, wherein at least the inner wall of the housing is at least partially coated with an insulating material, which insulating material may be light-absorbing. In another exemplary embodiment, a thin, light-absorbing layer may be provided between at least the inner wall of the housing and an insulating layer provided thereon.

The optical properties of the inner wall of the housing, outside of the portion where the meniscus is contactable in operation, may be altered (e.g. made rough) such that isotropic scattering occurs instead of specular reflection. The housing may be formed of a coloured metal (i.e. absorbing). For example, aluminium can be eloxated in a black colour, and other metals can be made coloured using other processes, as will be apparent to a person skilled in the art. Once again, it will be appreciated that any combination of the above measures can be employed.

Finally, in yet another exemplary embodiment of the invention, the housing may be made of a light-absorbing material.

It will be appreciated that the above measures are not necessarily limited to use with a cylindrical housing, but may be equally applicable for use with housings of other shapes, for example, conical.

In another exemplary embodiment, in respect of which the above-mentioned ghost image reduction/elimination measures may be applied, the lens may comprise a chamber defined by at least one side wall having an optical axis extending longitudinally through the chamber, wherein the chamber containing the fluids, which are in contact over a meniscus, the lens further comprising at least one pump for altering the relative volume of each of the fluids contained within the chamber.

In a first specific arrangement, the perimeter of the meniscus may be constrained by the side wall, and the at least one pump is arranged to controllably alter the position of the meniscus along the optical axis by altering the relative volume of each of the fluids contained within the chamber.

In an alternative, specific arrangement, the perimeter of the meniscus may be fixedly located on an internal surface of the chamber, and the at least one pump is arranged to controllably alter the shape of the meniscus by altering the relative volume of each of the fluids contained within the chamber.

In this case, the wettability of the internal surface of the chamber preferably varies longitudinally and is most preferably arranged to be controllably altered by the electrowetting effect.

The present invention extends still further to an image capture device comprising a variable focus lens or an image sensor as defined above, and to portable telecommunications apparatus incorporating such an image capture device.

These and other aspects of the present invention will be apparent from, and elucidated with reference to, the embodiments described herein.

An embodiment of the present invention will now be described by way of example only and with reference to the accompanying drawings, in which:

FIG. 1 is a schematic cross-sectional view of an imaging system including a variable focus lens of the electrowetting type, in which the principle of occurrence of ghost images is illustrated;

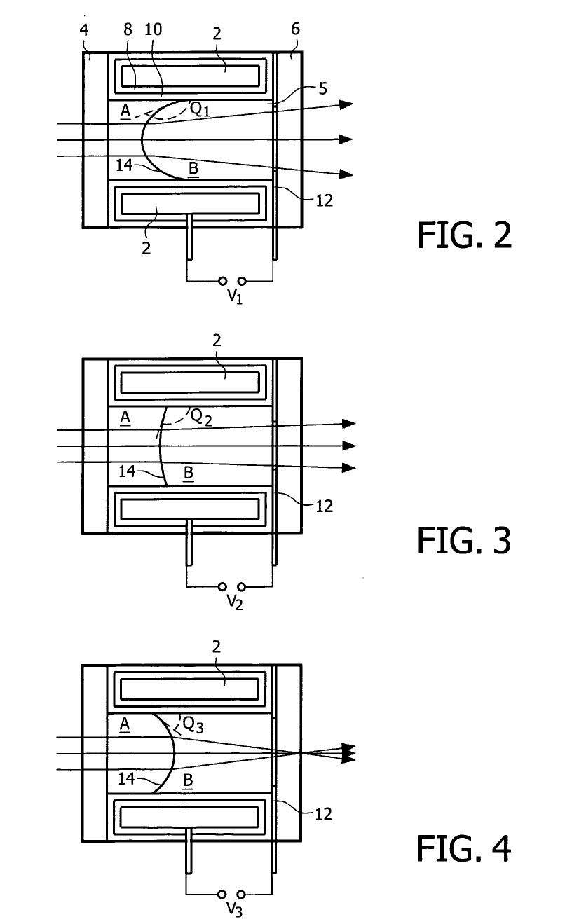

FIGS. 2 to 4 are schematic cross-sectional views of an adjustable lens according to a first exemplary type of variable focus lens embodiment of the present invention;

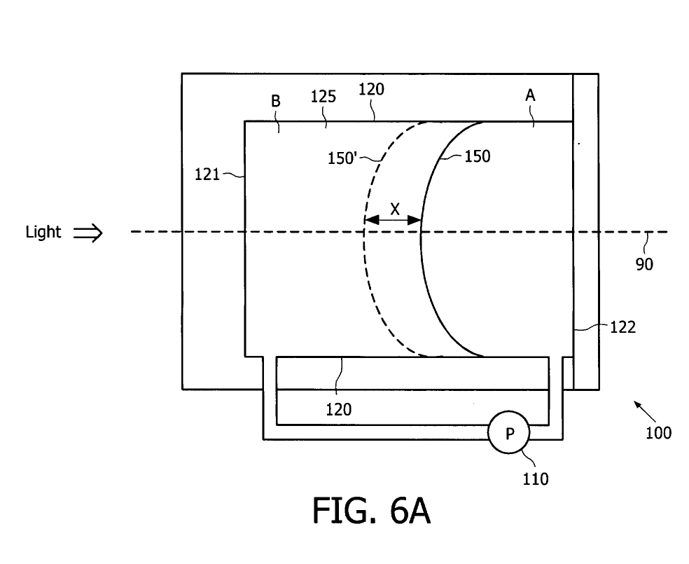

FIGS. 5A and 5B are schematic cross-sectional views illustrating the principle of operation of another exemplary type of variable focus lens, and the equivalent optical function provided by such a variable focus lens;

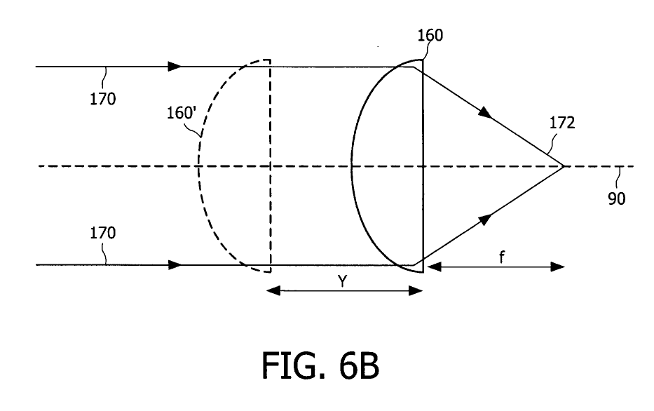

FIGS. 6A and 6B are schematic cross-sectional views illustrating the principle of operation of yet another exemplary type of variable focus lens, and the equivalent optical function provided by such a variable focus lens;

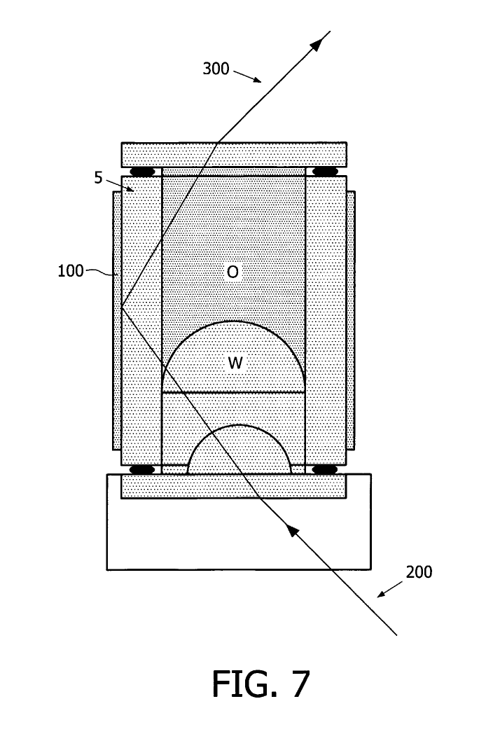

FIG. 7 is a schematic cross-sectional view of an image sensor according to a first exemplary embodiment of the present invention;

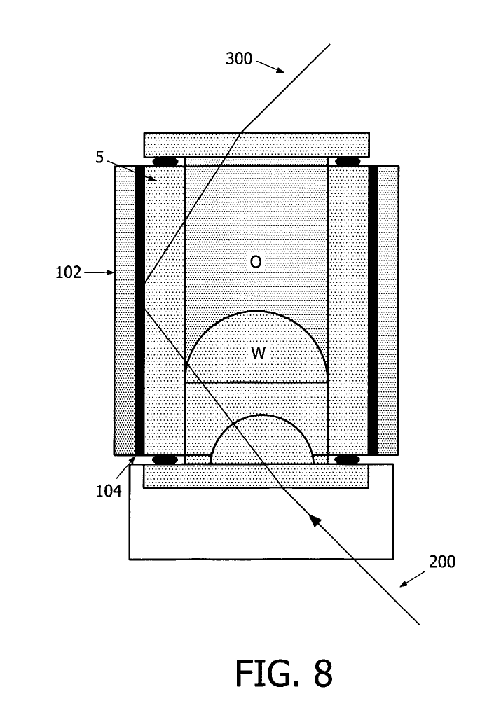

FIG. 8 is a schematic cross-sectional view of an image sensor according to a second exemplary embodiment of the present invention;

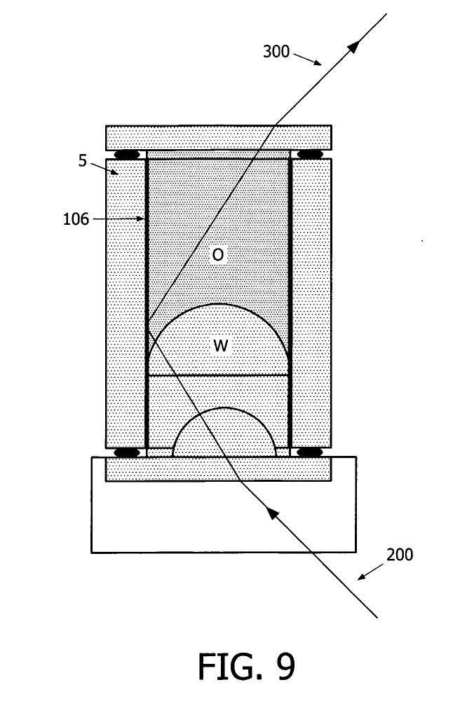

FIG. 9 is a schematic cross-sectional view of an image sensor according to a third exemplary embodiment of the present invention;

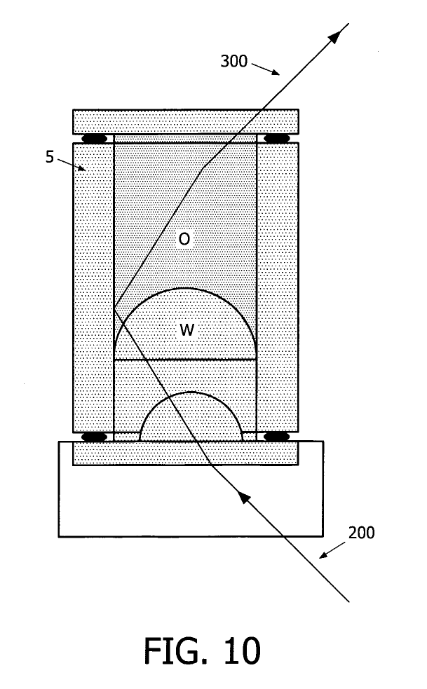

FIG. 10 is a schematic cross-sectional view of an image sensor according to a fourth exemplary embodiment of the present invention;

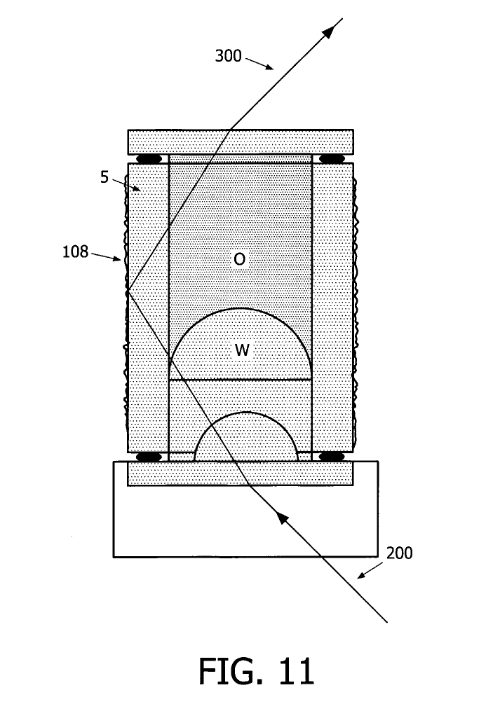

FIG. 11 is a schematic cross-sectional view of an image sensor according to a fifth exemplary embodiment of the present invention;

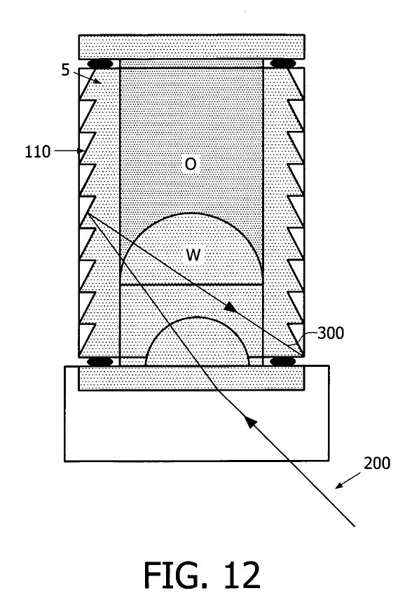

FIG. 12 is a schematic cross-sectional view of an image sensor according to a sixth exemplary embodiment of the present invention;

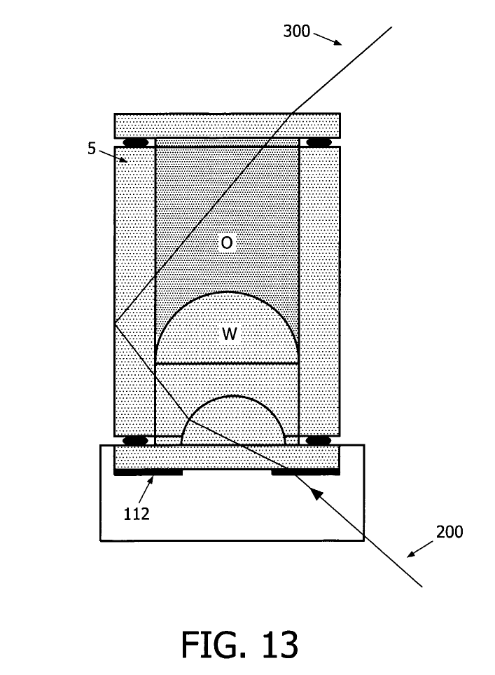

FIG. 13 is a schematic cross-sectional view of an image sensor according to a seventh exemplary embodiment of the present invention;

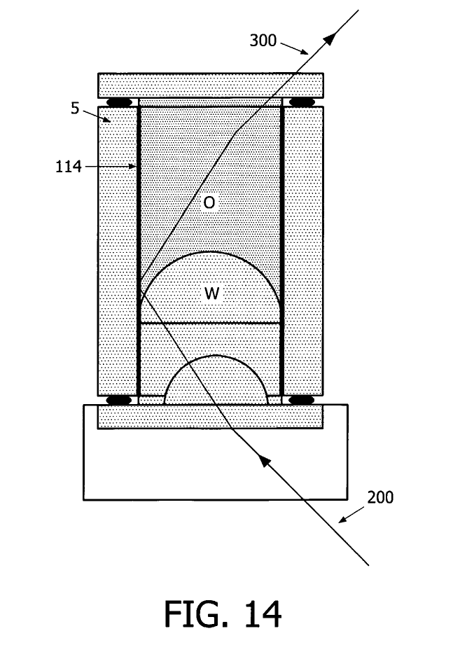

FIG. 14 is a schematic cross-sectional view of an image sensor according to a eighth exemplary embodiment of the present invention;

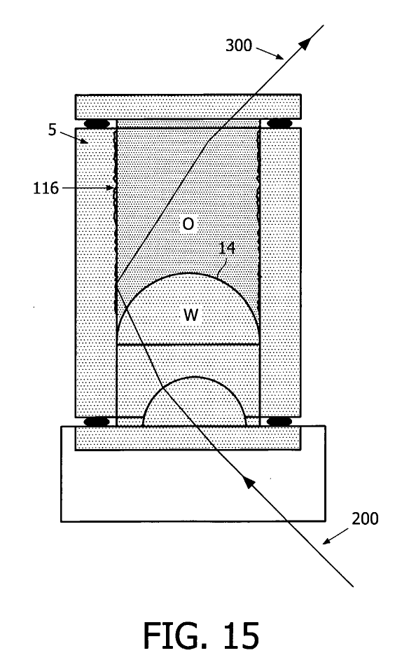

FIG. 15 is a schematic cross-sectional view of an image sensor according to a ninth exemplary embodiment of the present invention;

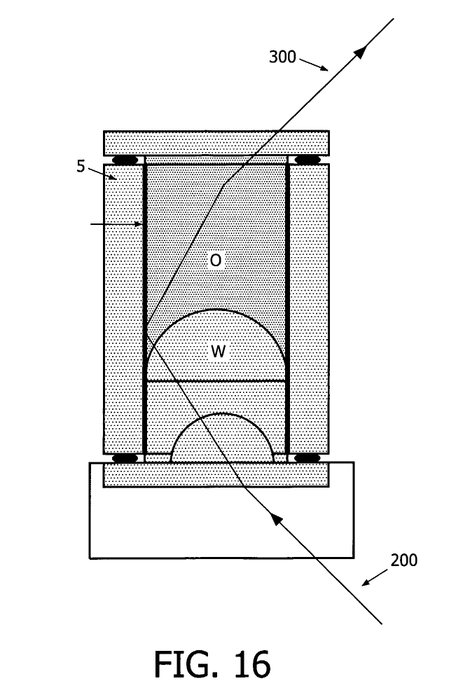

FIG. 16 is a schematic cross-sectional view of an image sensor according to a tenth exemplary embodiment of the present invention; and

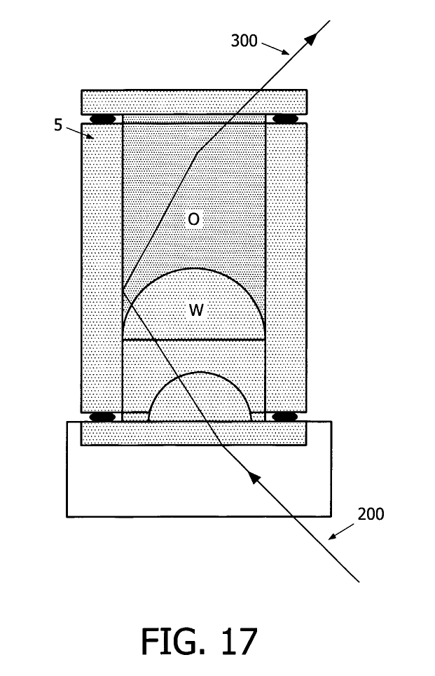

FIG. 17 is a schematic cross-sectional view of an image sensor according to an eleventh exemplary embodiment of the present invention.

Firstly, the principle of operation of a variable focus (or “electrowetting”) lens as described in International Patent Application No. WO 03/069380 will be explained. FIGS. 2 to 4 show a variable focus lens comprising a cylindrical first electrode 2 forming a capillary tube, sealed by means of a transparent front element 4 and a transparent back element 6 to form a fluid chamber 5 containing two fluids. The electrode 2 may be a conducting coating applied on the inner wall of a tube.

In this exemplary design, the two fluids consist of two non-miscible liquids in the form of an electrically insulating first liquid A, such as a silicone oil or an alkane, referred to herein further as “the oil”, and a polar and/or electrically conducting second liquid B, such as water containing a salt solution. The two liquids may be arranged to have an equal density so that the lens functions independently of orientation, i.e. without dependence on gravitational effects between the two liquids. This may be achieved, for example, by appropriate selection of the first liquid constituent; for example, alkanes or silicon oils may be modified by addition of molecular constituents to increase their density to match that of the salt solution. In this example, the fluids are selected such that the first fluid A has a higher refractive index than the second fluid B.

The first electrode 2 is a cylinder of inner radius typically between 1 mm and 20 mm. The electrode 2 is formed from a metallic material and is coated by an insulating layer 8, formed for example of parylene. The insulating layer is coated with a fluid contact layer 10, which reduces the hysteresis in the contact layer of the meniscus with the cylindrical wall of the fluid chamber. The wettability of the fluid contact layer by the second fluid is substantially equal on both sides of the intersection of the meniscus 14 with the fluid contact layer 10 when no voltage is applied between the first and second electrodes.

A second, annular electrode 12 is arranged at one end of the fluid chamber, in this case, adjacent the back element. The second electrode 12 is arranged with at least one part in the fluid chamber such that the electrode acts on the second fluid B. The two fluids A and B are non-miscible so as to tend to separate into two fluid bodies separated by a meniscus 14. When no voltage is applied between the first and second electrodes, the fluid contact layer has a higher wettability with respect to the first fluid A than the second fluid B. Due to electrowetting, the wettability of the second fluid B varies under the application of a voltage between the first electrode and the second electrode, which tends to change the contact angle of the meniscus at the three phase line (the line of contact between the fluid contact layer 10 and the two liquids A and B). The shape of the meniscus is thus variable in dependence on the applied voltage.

It should be noted at this stage that the meniscus between the first fluid and the second fluid is called concave if the meniscus is hollow as seen from the second fluid. If the first fluid is regarded as a lens, this lens would normally be called concave according to the definition in the previous sentence.

Referring to FIG. 2 of the drawings, when a low voltage V₁, e.g. between 0 V and 20 V, is applied between the electrodes, the meniscus adopts a first concave meniscus shape. In this configuration, the initial contact angle θ₁ between the meniscus and the fluid contact layer 10, measured in the fluid B, is for example, approximately 140°. Due to the higher refractive index of the first fluid A than the second fluid B, the lens formed by the meniscus, here called the meniscus lens, has a relatively high negative power in this configuration.

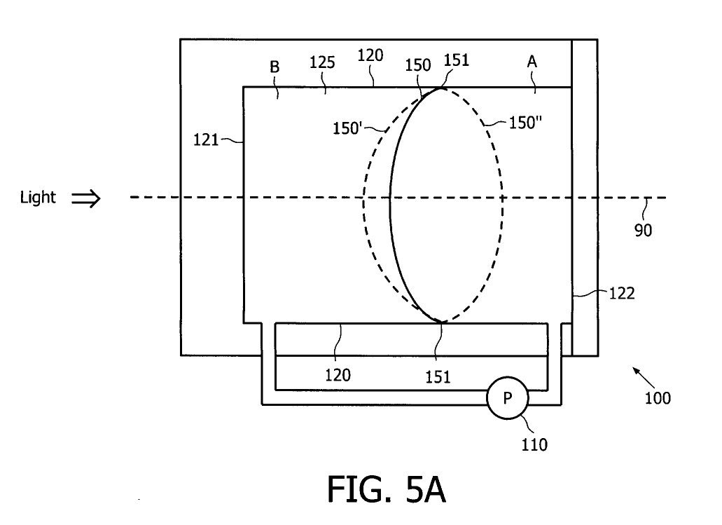

To reduce the concavity of the meniscus shape, a higher magnitude of voltage is applied between the first and second electrodes. Referring now to FIG. 3, when an intermediate voltage V₂, e.g. between 20 V and 150 V, depending on the thickness of the insulating layer, is applied between the electrodes, the meniscus adopts a second concave meniscus shape having a radius of curvature increased in comparison with the meniscus in FIG. 2. In this configuration, the intermediate contact angle θ₂ between the first fluid A and the fluid contact layer 10 is, for example, approximately 100°. Due to the higher refractive index of the first fluid A than the second fluid B, the meniscus lens in this configuration has a relatively low negative power.

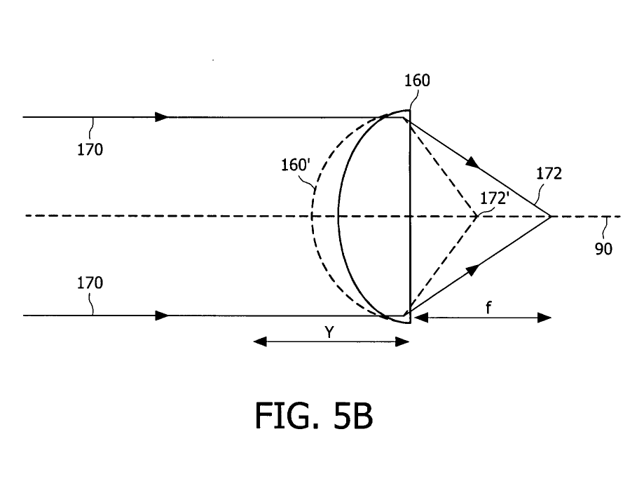

To produce a convex meniscus shape, a yet higher magnitude of voltage is applied between the first and second electrodes. Referring now to FIG. 4 of the drawings, when a relatively high voltage V₃, e.g. 150 V to 200 V, is applied between the electrodes, the meniscus adopts a meniscus shape in which the meniscus is convex. In this configuration, the maximum contact angle θ₃ between the first fluid A and the fluid contact layer 10 is, for example, approximately 60°. Due to the higher refractive index of the first fluid A than the second fluid B, the meniscus lens in this configuration has a positive power.

FIG. 5A shows a variable lens of the type described in unpublished European Patent Application No. 03101328.7. The lens 100 can be regarded as being formed of two distinct elements: a lens function formed by the meniscus 150 between two fluids A, B, and a pump 110 arranged to alter the shape of the lens function.

As stated above, a fluid is a substance that alters its shape in response to any force, that tends to flow or to conform to the outline of its chamber, and that includes gases, liquids, vapours, and mixtures of solids and liquids capable of flow.

The two fluids A, B, are substantially immiscible i.e. the two fluids do so mix. The two fluids A, B have different refractive indices. A lens function is thus provided by the meniscus 150 formed along the contact area of the two fluids, as the fluids have different refractive indices. A lens function is the ability of the meniscus 150 to focus (converge or diverge) one or more wavelengths of the light. In this particular embodiment, it is assumed that fluid A has a higher refractive index than fluid B.

The two fluids are preferably of substantially equal density, so as to minimise the effects of gravity upon the lens 100.

The fluids A, B are enclosed within a chamber 125. In this embodiment the chamber 125 takes the form of a longitudinally extending tube, the tube having side walls defined by internal surfaces 120. An optical axis extends longitudinally through the tube. In this particular example, the tube is a cylindrical tube, of constant circular cross-sectional area, and the optical axis is co-axial with the tube axis. Additional walls 121, 122 extend across the ends of the tubes so as to form a chamber 125 enclosing the fluids. At least the portions of the walls 121, 122 of the chamber 125 lying along the optical axis 90 are transparent. If desired, one or both of these walls 121, 122 may be lens shaped.

The meniscus 150 between the two fluids A, B extends transverse the optical axis 90 of the lens 100. The term transverse indicates that the meniscus crosses (i.e. it extends across) the optical axis, and it is not parallel to the optical axis; the meniscus 150 may cross the optical axis 90 at any desired angle. The perimeter of the meniscus 150 is defined by the side walls 120 of the tube.

Typically, in order to locate the fluids A, B within the desired portion of the chamber 125, different areas of the chamber will have different wettabilities for each fluid, such that each fluid will be attracted by a respective area. Wettability is the extent by which an area is wetted (covered) by a fluid. For instance, if the fluid A is water, and the fluid B is an oil, then the internal surface of the wall 122 may be hydrophilic so as to attract the fluid A, and not attract the fluid B.

The perimeter of the meniscus 150 contacts the surfaces 120 of the side walls of the tube. The perimeter of the meniscus if fixedly located on the surface 120. In other words, the position 151 at which the perimeter of the meniscus 150 touches the surface 120 is fixed i.e. the meniscus perimeter is pinned to the surface. In this particular embodiment, the menscus perimeter is fixed to the surface by an abrupt change in wettability of the surface at position 151 e.g. at position 151 the surface 120 changes from being hydrophobic to hydrophilic.

The shape of the meniscus 150 is determined by both the pressure difference between the two fluids and by the internal diameter of the cylinder. The meniscus 150 illustrated is convex (as viewed from fluid A).

A pump 110 connected to the fluid filled chamber 125 is arranged to pump quantities of one or more of the fluids to and from the chamber 125.

In this particular example, the pump 110 is arranged to simultaneously increase the volume of the fluid A and to decrease the volume of the fluid B (and vice versa), so as to maintain the same total volume of the two fluids within the chamber 125. The result will be that the shape of the meniscus 150 will be changed, as the perimeter of the meniscus is pinned to the surface 120.

For instance, if extra fluid A is added to the chamber 125, then the meniscus shape may change to be more convex i.e. to form the meniscus indicated by the dotted line 150′. Alternatively, if extra fluid B is added, then the meniscus may change shape to that indicated by the dotted line 150″ i.e. the meniscus becomes concave (as viewed from fluid A). It will be appreciated that by altering the volumes of the fluids within the chamber 125, then the meniscus shape can be changed from being convex, to planar, to concave.

It is expected that the maximum curvature of the meniscus shape would be when the meniscus forms a half-sphere. However, it will be appreciated that there is likely to be a threshold pressure at which the meniscus moves, when the pressure becomes so great that the pinning action of the meniscus is overcome, with the result that the meniscus will subsequently move position. Such a threshold pressure is dependent on the magnitude of the change in wettability.

FIG. 5B illustrates the effective optical function, when the refractive index of fluid A is higher than fluid B, provided by the meniscus 150 i.e. it is that of a piano convex lens 160, of focal length f. In other words, the meniscus 150 effectively provides the function of a lens 160, which would bring parallel light 170 (incident upon the lens in a direction parallel to the optical axis 90), to a focus 172 a distance f from the lens.

When the meniscus has changed shape (i.e. to the shape shown by the dotted line 150′ in FIG. 5A), then the effective lens function also changes, to that shown by dotted line 160′. As the meniscus 150′ is more curved than meniscus 150, then the lens will be of a higher power i.e. it will have a shorter focus length, bringing parallel light 170 in focus 172′, a shorter distance from the lens.

In the embodiment shown in FIG. 5A, the meniscus 150 is fixedly located by a change in the wettability of the surface. However, it will be appreciated that other techniques may be used to fix the position of the meniscus perimeter.

As illustrated by FIG. 6A of the drawings, another exemplary type of variable focus lens, as described in unpublished European Patent Application No 03101335.2, is similar in many respects to that of FIGS. 5A and 5B, and like elements thereof are denoted by the same reference numbers.

Thus, in the variable lens illustrated in FIG. 6A, the lens 100 can be regarded as being formed of two distinct elements: a lens function formed by the meniscus 150 between two fluids A, B, and a pump 110 arranged to alter the position of the lens function.

Once again, a fluid is a substance that alters its shape in response to any force, that tends to flow or to conform to the outline of its chamber, and that includes gases, vapours, liquids and mixtures of solids and liquids capable of flow.

As before, the two fluids A,B are substantially immiscible i.e. the two fluids do not mix. The two fluids A,B have different refractive indices. A lens function is thus provided by the meniscus 150 formed along the contact area of the two fluids, as the fluids have different refractive indices. A lens function is the ability of the meniscus 150 to focus (converge or diverge) one or more wavelengths of the light.

The two fluids are preferably of substantially equal density, so as to minimise the effects of gravity upon the lens 100.

The fluids A, B are enclosed within a chamber 125. In this embodiment, the chamber 125 takes the form of a longitudinally extending tube defined by internal surface or side walls 120. An optical axis extends longitudinally through the tube. In this particular example, the chamber is a cylindrical tube, of constant circular cross-sectional area, and the optical axis is co-axial with the tube axis. Additional walls 121, 122 extend across the ends of the tube so as to form a chamber 125 enclosing the fluids. At least the portions of the walls 121, 122 of the chamber 125 lying along the optical axis 90 are transparent.

The meniscus 150 between the two fluids A, B extends transverse the optical axis 90 of the lens 100. The term transverse indicates that the meniscus crosses (i.e. it extends across) the optical axis, and it is not parallel to the optical axis; the meniscus 150 may cross the optical axis 90 at any desired angle. The perimeter of the meniscu 150 is defined by the side walls 120 of the chamber.

Typically, in order to locate the fluids A, B within the desired portion of the chamber 125, different areas of the chamber will have different wettabilities for each fluid, such as each fluid will be attracted by a respective area. Wettability is the extent by which an area is wetted (covered) by a fluid. For instance, if the fluid 130 is a polar fluid, and the fluid 140 a non-polar fluid, then the internal surface of the wall 122 may be hydrophilic so as to attract the polar fluid A, and not attract the non-polar fluid B.

The shape of the meniscus 150 is determined by the contact angle of the meniscus edge with the internal surfaces 120. Hence the meniscus shape is dependent upon the wettability of the surfaces 120. The meniscus 150 illustrated is convex (as viewed from fluid 130), but the meniscus may be any desired shape e.g. convex, concave or substantially planar.

A pump 110 connected to the fluid filled chamber 125 is arranged to pump quantities of one or more of the fluids to and from the chamber 125. In this particular example, the pump 110 is arranged to simultaneously increase the volume of the fluid A and to decrease the volume of the fluid 140 and vice versa), so as to maintain the same total volume of the two fluids within the chamber 125. The result will be that the meniscus 150 will be moved along the optical axis 90 as respective fluids are added e.g. if extra fluid A is added, then the meniscus may move a distance X along the optical axis, to the position indicated by the dotted line 150′. In this particular embodiment, the shape of the meniscus is not altered by this movement (as the surfaces 120 are of uniform wettability), only the location of the meniscus along the optical axis 90.

FIG. 6B illustrates the effective optical function provided by the meniscus 150 i.e. it is that of a piano convex lens 160, of focal length f. In other words, the meniscus 150 effectively provides the function of a lens 160, which would bring parallel light 170 (incident upon the lens in a direction parallel to the optical axis 90), to a focus 172 a distance f from the lens.

When the meniscus has moved (i.e. to the position shown by the dotted line 150′ in FIG. 5A), then the effective position of the lens also moves, to that shown by dotted line 160′. As the menisci 150, 150′ are the same shape, then equally they have the same equivalent lens shapes 160, 160′ (and consequently will have the same lens properties i.e. the same power and focal distance).

FIG. 6A indicates that the mensicus is displaced a distance X to the left when it is moved from position 150 to position 150′. Similarly, the equivalent lens function 160′ will also be to the left of the lens function 160. If the ray diagram of FIG. 6B is an illustration of the equivalent functions in vacuo, then 160′ will be to the left of 160 by a distance Y, where Y=X/nA, with nA being the refractive index of the fluid A.

Referring back to the embodiment of FIGS. 1 to 3 of the drawings, if the inner surface of the fluid chamber 5 is reflective, then reflections therefrom will give rise to ghost images. This is especially true in accordance with one arrangement, whereby the cylindrical fluid chamber 5 or housing is made of polished metal or the like, in which case the imaging module will be very susceptible to the occurrence of ghost images.

In another arrangement, the fluid chamber 5 may be formed of a substantially transparent material, i.e. it may comprise (say) a transparent glass cylinder with transparent electrodes and coatings, in which case the imaging module is again very susceptible to the occurrence of ghost images, especially if the outer part of the cylinder interfaces with air, when ghost images arise from reflections on the outer boundary of the housing due to the fact that the refractive index difference between the fluid and the housing is relatively small compared to the refractive index change between the housing and the surrounding medium, i.e. there is a significant refractive index step).

It is an object of the invention to reduce or substantially prevent the occurrence of ghost images arising in camera modules employing electrowetting focusing lenses.

Referring to FIG. 7 of the drawings, and considering in the first instance, the case of a transparent fluid chamber 5, one way in which the occurrence of ghost images can be reduced or substantially eliminated is to coat the outer surface of the housing 5 with a light absorbing coating 100, for example, black paint, or the housing 5 could be coupled with a light absorbing outer body, for example, it could be encapsulated in a mount 102 made of light absorbing material, as shown in FIG. 8 of the drawings, preferably with a light coupling substance 104 there between.

A thin, absorbing coating 106 could be provided between the inside of the cylinder 5 and the electrode (not shown) that covers the inside, as shown in FIG. 9, or an absorbing material, such as soot, could be mixed through the transparent cylinder material before it is shaped into a cylinder. In fact, the cylinder 5 itself could be made of a translucent/absorbing material, as illustrated in FIG. 10 of the drawings, and suitable absorbing materials will be apparent to a person skilled in the art.

In another exemplary embodiment of the present invention, as shown in FIG. 11, the above-mentioned object could be achieved by making the outer surface 108 of the housing 5 highly scattering by making this outer surface rough. In yet another exemplary embodiment, the outer housing geometry could be shaped such that the ghosting image does not reach the sensor. Alternatively, such shaping could be substituted by the provision of a sawtooth-like blazed (Fresnel) grating structure 110, as illustrated in FIG. 12, so as to save space. The concept upon which this type of blazed Fresnel structure is based is described in detail in International Patent Application No. WO 02/41303.

Of course, combinations of the above measures can be used.

Considering now the case where the housing 5 is made of metal, the interior wall will be highly reflective, which will give rise to ghost images. The metal housing is, in general, at least coated with an insulating layer and, in order to reduce or substantially eliminate the occurrence of ghost images, the insulating layer 114 may be formed of a light absorbing material, as illustrated in FIG. 14 of the drawings, or a thin absorbing coating may be applied between the metal housing and the above-mentioned insulating layer. The metal wall, in the portions where the meniscus 14 is not contactable therewith in operation, can be made rough so that isotropic scattering occurs at these portions 116 instead of specular reflections, as shown in FIG. 15. In yet another exemplary embodiment, the metal of which the cylinder is formed could be coloured (absorbing), or a light absorbing coating 118 may be provided on the inner wall of the housing 5, as shown in FIG. 16. For example, aluminium can be eloxated in a black colour. Other metals can be made coloured by different processes, as will be apparent to a person skilled in the art.

In yet another exemplary embodiment, the cylindrical fluid chamber 5 could simply be made of an absorbing material, for example, black plastic, as illustrated in FIG. 17.

The cylindrical fluid chamber 5 or the electrode 2 could even be made of (or coated with) graphite (which is black which would render them less reflective than if they were made of, or coated with, metal, even though polished graphite can be quite reflective.

In all cases, the letter ‘O’ in FIGS. 7 to 17 denotes “oil” and corresponds to fluid A referred to above, and the letter ‘W’ denotes “water” and corresponds to fluid B referred to above. Furthermore, in all cases, the reference numeral ‘200’ denotes an unwanted ray coupled into the system and reference numeral ‘300’ denotes the ghosting ray eliminated as a result of the respective exemplary embodiment of the invention, illustrated schematically.

The above measures for reducing or eliminating ghost images retention apply equally to the types of variable focus lenses described with reference to FIGS. 5A and 5B and FIGS. 6A and 6B, and all other variable focus lenses comprising a first fluid and a second fluid, the fluids being non-miscible, in contact over a meniscus and having different indices of refraction, wherein the shape and/or position of the meniscus is variable such that the lens function of the variable focus lens can be selectively controlled.

The present invention finds particular application in image capture modules employing electrowetting lenses, incorporated in, for example, portable telecommunications apparatus, such as mobile telephones and the like.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of reducing or substantially eliminating the occurrence of ghost images in a variable focus lens comprising a housing (5) in which is provided a first fluid (A) and a second fluid (B), the fluids (A,B) being non-miscible, in contact over a meniscus (14) and having different indices of refraction, the shape and/or position of said meniscus (14) being variable so as to selectively control the lens function of said variable focus lens, a portion of the inner wall of said housing (14) being contactable by said meniscus (14) during operation, which portion of said inner wall is substantially smooth, the method comprising configuring or altering the optical properties of at least a portion of the wall of said housing (5) so as to at least reduce the reflectivity thereof.

2. A method according to claim 1, wherein the optical properties of the inner and/or outer wall of the housing (5), and/or the bulk of the wall of the housing (5) is configured or altered so as to at least reduce the reflectivity thereof.

3. A method according to claim 1, wherein the housing (5) is formed of a substantially transparent material, and wherein at least a portion of the outer surface of said housing (5) is provided with a light-absorbing coating or layer.

4. A method according to claim 1, wherein at least a portion of the outer surface of the housing (5) is highly scattering.

5. A method according to claim 1, wherein the outer surface of the housing (5) is coupled with a light-absorbing outer body.

6. A method according to claim 1, wherein the second fluid (B) is axially displaced from the first fluid (A).

7. A method according to claim 6, wherein the lens further comprises a first electrode (2) and a second electrode (12) wherein the shape of the meniscus (14) can be controlled in dependence on the application of a voltage between said first electrode (2) and said second electrode (12).

8. A method according to claim 7, wherein the first electrode (2) comprises a conducting coating applied to the inner wall of the housing (5), and a light-absorbing coating is provided between the inner wall of the housing (5) and the electrode (2).

9. A method according to claim 6, wherein the lens comprises a housing (125) defined by at least one side wall having an optical axis extending longitudinally through the housing (125), wherein the chamber containing the fluids (A, B), which are in contact over a meniscus (15), the lens further comprising at least one pump (110) for altering the relative volume of each of the fluids (A,B) contained within the housing (125).

10. A method according to claim 9, wherein the perimeter of the meniscus (15) is constrained by the side wall, and the at least one pump (110) is arranged to controllably alter the position of the meniscus (150) along the optical axis by altering the relative volume of each of the fluids (A,B) contained within the housing (125).

11. A method according to claim 9, wherein the perimeter of the meniscus (150) is fixedly located on an internal surface of the housing (125), and the at least one pump (110) is arranged to controllably alter the shape of the meniscus (15) by altering the relative volume of each of the fluids (A,B) contained within the housing (125).

12. A method according to claim 1, wherein the housing is made of a translucent and/or absorbing material.

13. A method according to claim 1, wherein a light absorbing material is mixed through the housing material before it is moulded into a housing (5).

14. A method according to claim 1, wherein the outer wall of the housing (5) is provided with a diffractive structure.

15. A method according to claim 14, wherein the outer wall of the housing (5) comprises a blazed Fresnel structure.

16. A method according to claim 1, wherein the housing (5) is formed of an opaque, reflective material.

17. A method according to claim 16, wherein at least the inner wall of the housing (5) is at least partially coated with an insulating material.

18. A method according to claim 17, wherein the insulating material is light-absorbing.

19. A method according to claim 1, wherein a thin, light-absorbing layer is provided between at least the inner wall of the housing (5) and an insulating layer provided thereon.

20. A method according to claim 1, wherein the optical properties of the inner wall of the housing (5), outside of the portion where the meniscus (14) is contactable in operation, is altered such that isotropic scattering occurs.

21. A method according to claim 1, wherein the housing (5) is formed of a coloured metal.

22. A method according to claim 1, wherein the housing (5) is made of a light-absorbing material.

23. A variable focus lens comprising a housing (5) in which is provided a first fluid (A) and a second fluid (B), the fluids (A,B) being non-miscible, in contact over a meniscus (14) and having different indices of refraction, the shape and/or position of said meniscus (14) being variable so as to selectively control the lens function of said variable focus lens, a portion of the inner wall of said housing (5) being contactable by said meniscus (14) during operation, which portion of said inner wall is substantially smooth, wherein the optical properties of at least a portion of the wall of said housing (5) has been configured or altered according to a method of claim 1 so as to at least reduce the reflectivity thereof and thereby reduce or substantially eliminate the occurrence of ghost images during operation.

24. An image sensor having a variable focus lens comprising a housing (5) in which is provided a first fluid (A) and a second fluid (B), the fluids (A,B) being non-miscible, in contact over a meniscus (15) and having different indices of refraction, the shape and/or position of said meniscus (15) being variable so as to selectively control the lens function of said variable focus lens, the image sensor further comprising means for reducing or substantially eliminating the occurrence of ghost images in said variable focus lens according to claim 1.

25. An image sensor according to claim 24, wherein the housing (5) is shaped such that at least some ghost images do not reach image sensor.

26. An image sensor according to claim 24, comprising a stop arranged and configured to intercept at least a portion of ghosting occurring as a result of specular reflection of light by the housing.

27. An image capture device comprising a variable focus lens according to claim 23.

28. Portable telecommunications apparatus incorporating an image capture device according to claim 27.
